(19) United States
(12) Patent Application Publication
(10) Pub. No.: US 2006/0285698 A1
(43) Pub. Date: Dec. 21, 2006

(54) VEHICLE SYMMETRIC ACOUSTIC SYSTEM AND CONTROL METHOD THEREOF

(76) Inventor: Byong Yong Kong, Icheon-shi (KR)

Correspondence Address: IPLA P.A., 3580 WILSHIRE BLVD., 17TH FLOOR, LOS ANGELES, CA, 90010, US

(21) Appl. No.: 11/419,708

(22) Filed: May 22, 2006

(30) Foreign Application Priority Data
Jun. 21, 2005 (KR) 10-2005-0053574

(51) Int. Cl. H04B 1/00

(52) U.S. Cl. 381/86; 381/56

(57) ABSTRACT

A vehicle acoustic system with a plurality of speakers and a control method thereof are provided. The system includes a plurality of microphones installed at a listener position, and outputting an audible sound; a position selector for selecting one of audio signals; an audio measurement unit for analyzing the audio signal and generating signal level and sound image information; an audio signal generator for generating audio data; a digital signal processor for controlling a signal level and a sound image of the audio data, converting the audio data into an audio signal, and outputting the converted audio signal; and a microcomputer for receiving the signal level and sound image information, and comparing the received signal level and sound image information with previously stored reference signal level and sound image information.

### BACKGROUND OF THE INVENTION

1. Field of the Invention

The present invention relates to a vehicle acoustic system, and more particularly, to a vehicle symmetric acoustic system and a control method thereof, for allowing ride listeners to feel senses of imaging of a sound and a sound image depending on their positions in a vehicle.

2. Description of the Related Art

In general, a vehicle is basically equipped with an acoustic system. The vehicle acoustic system includes a car audio and, a left front speaker (FL), a right front speaker (FR), a left rear speaker (RL), and a right rear speaker (RR) installed at an upper end of a dashboard within the vehicle.

Audio signals from the respective left and right speakers, that is, FL and FR (or the RL and the RR) are set to have the same output levels. However, on an aspect of a car structure, listeners riding in the vehicle have seats asymmetrically positioned between the speakers. For example, a driver has a driver seat biased to the FL, and a passenger has a passenger seat biased to the FR. Accordingly, in a conventional art, in order for the driver to listen an audio signal with a sense of imaging at his/herself position, he/she turns to the right a balance control switch controlling left and right audio output levels, to raise the output level of the audio signal outputted through the right speaker, that is, the FR. For the listener riding on the passenger seat, the output level of the audio signal outputted through the FL should be more raised.

FIG. 1 illustrates a concept of acoustic symmetry for a position of a listener riding in a vehicle in a conventional acoustic system.

FIG. 1A illustrates a position at which the listener can feel a sense of imaging when audio signals outputted from left and right speakers have the same output levels. FIG. 1B illustrates a case where the output level (length of arrow) of the audio signal outputted from the FL is greater set to allow the listener to feel the sense of imaging on the passenger seat. FIG. 1C illustrates a case where the output level of the audio signal outputted from the FR is greater set to allow the listener to feel the sense of imaging on the driver seat.

As described above, in the conventional acoustic system, the listener riding in the vehicle can raise and adjust a sound level outputted from a remote speaker in order to listen left and right sounds with the same volume level, but there is a drawback of not being capable of adjust a sound image to be substantially balanced.

### SUMMARY OF THE INVENTION

Accordingly, the present invention is directed to a vehicle symmetric acoustic system and a control method thereof that substantially overcome one or more of the limitations and disadvantages of the conventional art.

One object of the present invention is to provide a vehicle symmetric acoustic system and a control method thereof, for allowing ride listeners to feel senses of imaging of a sound and a sound image depending on their positions in a vehicle.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a vehicle acoustic system with a plurality of speakers, the system including: a plurality of microphones installed at a position of a listener riding in a vehicle, and outputting an audible sound as an electric audio signal; a position selector connected with the microphones, and selecting one of the audio signals outputted from the microphones under a predetermined control; an audio measurement unit for analyzing the audio signal outputted from the position selector, and generating signal level and sound image information for the respective speakers; an audio signal generator for generating audio data under a predetermined control; a digital signal processor for, under a predetermined control, controlling a signal level and a sound image of the audio data to be outputted to the respective speaker, converting the audio data into an audio signal, and outputting the converted audio signal as an audible sound through the corresponding speaker; and a microcomputer for controlling the audio signal generator to generate the audio data, controlling the position selector to select the microphone of the selected position when the listener position is selected by the listener, receiving the signal level and sound image information, comparing the received signal level and sound image information with previously stored reference signal level and sound image information to calculate a difference value between the signal levels and a difference value between the sound images, and controlling the digital signal processor depending on the respective difference values to control the signal level and the sound image of the audio signal outputted through each of the speakers.

In another aspect of the present invention, there is provided a vehicle acoustic system with a plurality of speakers, the system including: an audio signal generator for generating audio data under a predetermined control; a digital signal processor for, under a predetermined control, controlling a signal level and a sound image of the audio data to be outputted to the respective speakers, converting the audio data into an audio signal, and outputting the converted audio signal as an audible sound through the corresponding speaker; and a microcomputer having signal level and sound image information on the audio signals outputted to the respective speakers depending on a listener position, and controlling the audio signal generator to generate the audio data, reading the signal level and sound image information corresponding to the respective speakers for the selected position when the listener position is selected by the listener, and controlling the digital signal processor depending on the read signal level and sound image information to control the signal level and the sound image of the audio signal outputted through the respective speakers.

In a further another aspect of the present invention, there is provided a control method of a vehicle acoustic system with a plurality of speakers, the method including the steps of: determining whether or not a listener position is selected by a listener; upon selection of the listener position, outputting audio source signals as audible sounds through the speakers; receiving and analyzing the audio source signals from the respective speakers through a microphone installed at a position corresponding to the listener position, and generating signal level and sound image information on audio signals outputted from the respective speakers; receiving the generated signal level and sound image information, and comparing the received signal level and sound image information with reference signal level and sound image information to calculate a difference value between signal levels and a difference value between sound images; and controlling the signal level and the sound image of the audio signal to be outputted to the respective speakers, using the signal level and sound image information based on the respective difference values.

In a still further another aspect of the present invention, there is provided a control method of a vehicle symmetric acoustic system having signal level and sound image information on an audio signal outputted to speakers depending on a listener position, the method including the steps of: determining whether or not a listener position is selected; upon selection of the listener position, reading the signal level and sound image information for each speaker corresponding to the selected listener position; and controlling a signal level and a sound image of an audio signal to be outputted to each speaker, depending on the read signal level and sound image information.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a concept of acoustic symmetry for a position of a listener riding in a vehicle in a conventional acoustic system;

FIG. 2 illustrates a construction of a symmetric acoustic system according to the present invention;

FIG. 3 is a flowchart illustrating a control method of a symmetric acoustic system according to the first embodiment of the present invention; and

FIG. 4 is a flowchart illustrating a control method of a symmetric acoustic system according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention includes a microphone installed at each position of a listener riding in a vehicle, and analyzes a sound inputted through the microphone selected by the listener, and automatically controls a volume level and a sound image of the sound outputted through a speaker.

Further, the present invention receives a listener position signal caused by the ride listener and, upon receipt of the listener position signal, reads volume and sound image information for each speaker previously set depending on the listener position, and automatically controls the sound outputted through the speakers depending on the read information.

Hereinafter, a construction and an operation of a symmetric acoustic system according to the present invention will be described with reference to the attached drawings.

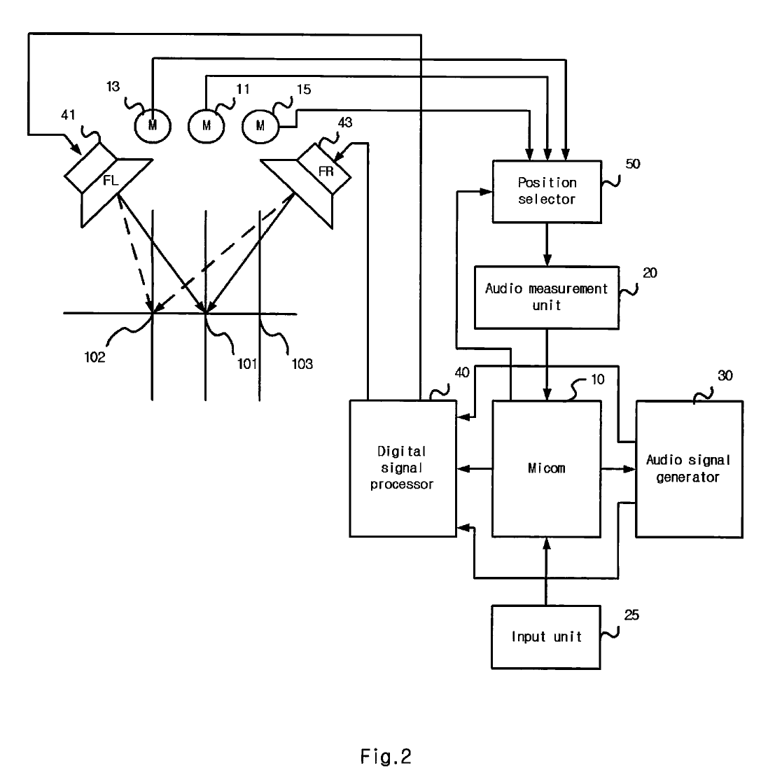

FIG. 2 illustrates the construction of the symmetric acoustic system according to the present invention. FIG. 2 illustrates the construction of the symmetric acoustic system including front speakers, that is, a right front speaker (FR) and a left front speaker (FL). The present invention is identically applicable to a symmetric acoustic system including four or more speakers including rear speakers, that is, a right rear speaker (RR) and a left rear speaker (RL). However, in the first embodiment of the present invention, the microphones should be provided depending on number of speakers. In the second embodiment of the present invention, the sound image information for each speaker depending on the position of the listener should be previously stored.

In detail, referring to FIG. 2, the inventive symmetric acoustic system includes a microcomputer 10, an input unit 25, an audio measurement unit 20, an audio signal generator 30, a digital signal processor 40, a position selector 50, a plurality of the speakers (FL and FR), the microphones 13 and 15 corresponding to the respective positions of the speakers, the microphone 11 disposed to provide a sound image with a sense of imaging under a general setting. A reference numeral 101 denotes a triangle division position for providing a sound with the sense of imaging, a reference numeral 103 denotes a driver seat position, and a reference numeral 105 denotes a passenger seat position.

The microcomputer 10 controls a general operation of the symmetric acoustic system according to the present invention.

The input unit 25 includes a selection key for selecting the position of the listener riding in the vehicle. When the listener presses the position selection key, key data on the position selection key is generated and outputted to the microcomputer 10.

The position selector 50 is connected with microphones 11, 13, and 15. Under the control of the microcomputer 10, the position selector 50 selects one of the microphones, and outputs an audio signal from the selected microphone to the audio measurement unit 20. The audio signal is a mixture of sound signals outputted from the FL 41 and FL 43 of FIG. 2.

The audio measurement unit 20 separates and analyzes the outputted sound signals of the speakers from the audio signal, and generates and outputs signal level information, that is, volume level information between the sound signals and the sound image information to the microcomputer 10. The signal level information can be information on a signal level difference between the signals outputted from the FL 41 and the FR 43. The sound image information can be information on a sound image difference between the signals outputted from the FL 41 and the FR 43. In case where the analyzed information is the signal level difference and sound image difference information, the signal level information and the sound image information measured in the microphones 11 can theoretically have a value of zero, and the signal level difference and sound image difference information being the analyzed information on the audio signals outputted from the microphones 13 and 15 have a value of more than zero.

The audio signal generator 30 being a radio, a cassette, a MP3 player, a CD or DVD player reads the audio signal or audio data from a multimedia acoustic medium, and outputs the read audio signal or data to the digital signal processor 40. In case where the multimedia acoustic medium is an analogue medium, the audio signal is converted into the audio data and is outputted to the digital signal processor 40. The audio signal generator 30 generates audio source data for providing the sound with the sense of imaging depending on the listener position under the control of the microcomputer 10, and outputs the generated audio data to the digital signal processor 40.

Under the control of the microcomputer 10, the digital signal processor 40 digitally processes the audio data outputted from the audio signal generator 30, controls the signal level and the sound image, converts the processed data into an analogue audio signal, and outputs the converted audio signal through the corresponding speaker.

The microphones 13 and 15 are installed to be close to listener's eyes. For one example, the microphones 13 and 15 can be installed at head pads of a driver seat and a passenger seat. In order to facilitate separation of the left and right sound signals in the audio measurement unit 20, a stereo microphone can be also used.

The microphone 11 is installed at the triangle division position for providing the sense of imaging so as to obtain reference signal level and sound image information according to the first embodiment of the present invention.

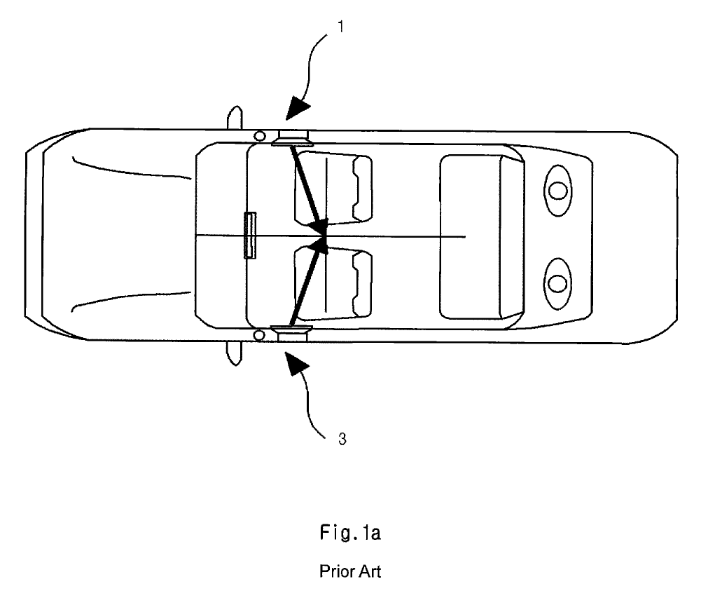

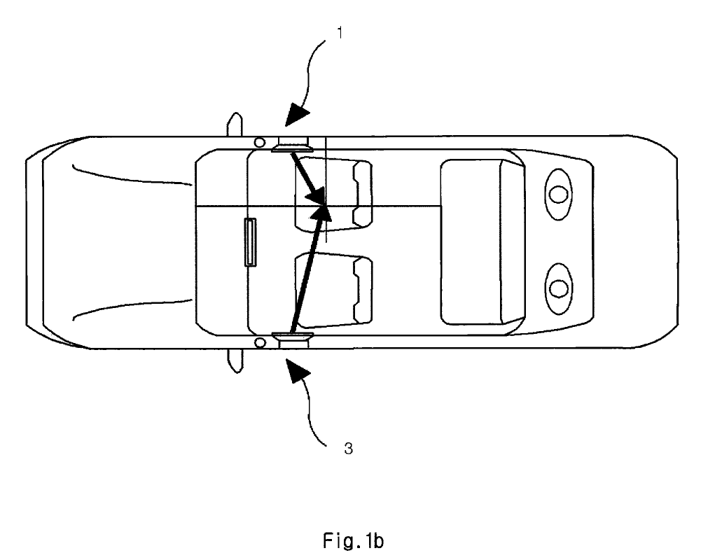

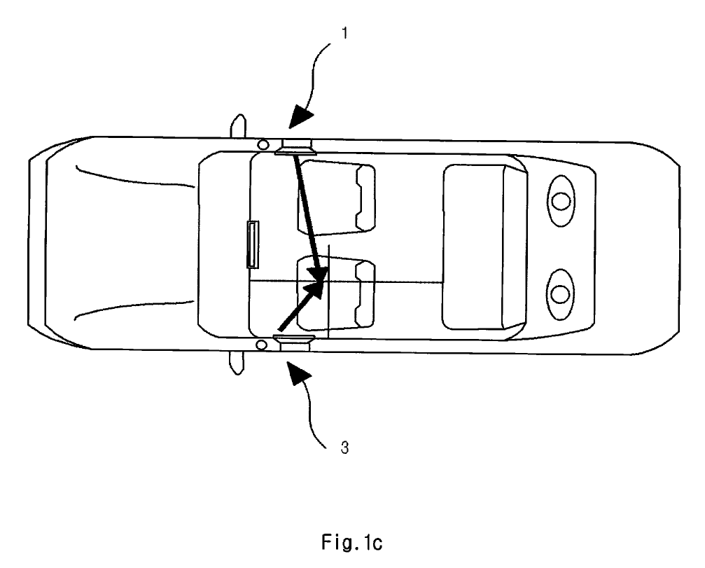

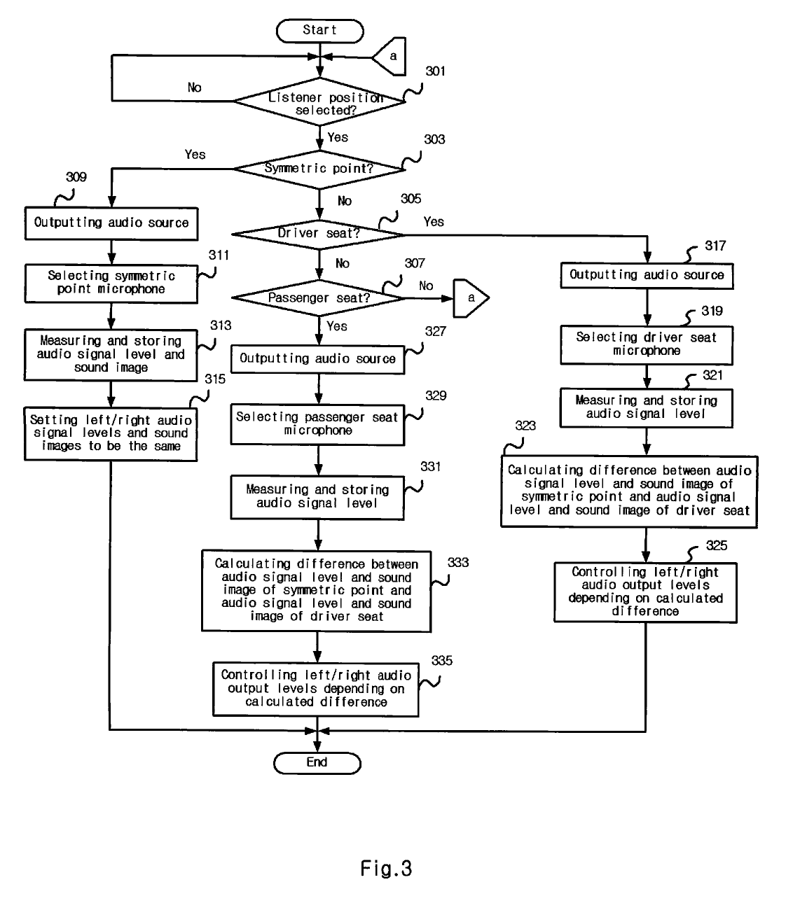

FIG. 3 is a flowchart illustrating a control method of the symmetric acoustic system according to the first embodiment of the present invention. Hereinafter, a description will be made with reference to FIGS. 1 and 2.

First, in Step 301, the microcomputer 10 determines whether or not to receive the data on the listener position selection key for selecting the listener position from the input unit 25. If it is determined to receive the position selection key data, in Steps 303, 305, and 307, the microcomputer 10 analyzes the selection key data to sequentially determine whether the selected position is a symmetric point 101, the driver seat 102, or the passenger seat 103.

If it is determined to be the symmetric point 101, in Step 309, the microcomputer 10 controls the audio signal generator 30 to generate and output the audio source data to the digital signal processor 40. The digital signal processor 40 digitally processes the received audio source data using default signal level and sound image information under the control of the microcomputer 10, converts the processed data into the analogue signal, and outputs the converted analogue signal through the speaker. Here, the selected position is the symmetric point 101 and therefore, in Step 311, the microcomputer 10 outputs a selection control signal for selecting the microphone 11 to the position selector 50. Upon selection of the microphone 11, in Step 313, the microcomputer 10 converts an audible sound outputted from the FL 41 and the FR 43 into the audio signal through the microphone 11, and outputs the converted audio signal to the audio measurement unit 20 through the position selector 50. Then, the audio measurement unit 20 analyzes the audio signal, and generates and outputs the signal level and sound image information to the microcomputer 10. The microcomputer 10 receives the signal level and sound image information, and stores the received signal level and sound image information in a built-in memory.

Upon storing of the signal level and sound image information for the symmetric point 101, in Step 315, the microcomputer 10 controls the digital signal processor 40 depending on the signal level and sound image information for the symmetric point 101 to set the signal level and the sound image of the sound outputted through the FL 41 and the FR 43.

On the contrary, if the position selected in the Step 305 is determined to be the driver seat 102, in Step 317, the microcomputer 10 controls the audio signal generator 30 to output the audio source data to the digital signal processor 40. At this time, under the control of the microcomputer 10, the digital signal processor 40 digitally processes the audio source data depending on previously set signal level and sound image information, and outputs the audible sound through the corresponding speaker. After outputting of the audio source data, in Step 319, the microcomputer 10 outputs the selection control signal for selecting the driver seat microphone 13 to the position selector 50.

Upon selection of the microphone 13, in Step 321, the microcomputer 10 generates the audio signals for the audible signals outputted from the FL 41 and the FR 43 through the selected microphone 13, and outputs the generated audio signals to the audio measurement unit 20 through the position selector 50. Then, the audio measurement unit 20 analyzes the audio signal, measures the signal level and sound image information for the respective left and right speakers, that is, FL 41 and FR 43, and outputs the measured signal level and sound image information to the microcomputer 10. Then, the microcomputer 10 receives and stores the measured signal level and sound image information for the respective speakers.

After storing of the signal level and sound image information, in Step 323, the microcomputer 10 compares the measured signal level and sound image information of the symmetric point 101 with the measured signal level and sound image information of the driver seat 102 to calculate a difference value therebetween. In Step 325, the microcomputer 10 controls the digital signal processor 40 to compensate subsequent audio signals with the calculated difference value and output the audible sound through the corresponding speaker.

If the selection position is determined to be the passenger seat 103 in the Step 307, in Step 327, the microcomputer 10 controls the audio signal generator 30 to output the audio source data to the digital signal processor 40. At this time, under the control of the microcomputer 10, the digital signal processor 40 digitally processes the audio source data depending on previously set signal level and sound image information, and outputs the audible sound through the corresponding speaker. After outputting of the audio source data, in Step 329, the microcomputer 10 outputs a selection control signal for selecting the passenger seat microphone 15 to the position selector 50.

Upon selection of the microphone 15, in Step 331, the microcomputer 10 generates the audio signals for the audible sounds outputted from the FL 41 and the FR 43 through the selected microphone 15, and outputs the generated audio signals to the audio measurement unit 20 through the position selector 50. Then, the audio measurement unit 20 analyzes the audio signal, measures the signal level and sound image information for the respective left and right speakers, that is, FL 41 and FR 43, and outputs the measured signal level and sound image information to the microcomputer 10. Then, the microcomputer 10 receives and stores the measured signal level and sound image information for the respective speakers.

After storing of the signal level and sound image information, in Step 333, the microcomputer 10 compares the measured signal level and sound image information of the symmetric point 101 with the measured signal level and sound image information of the passenger seat 103 to calculate a difference value therebetween. In Step 335, the microcomputer 10 controls the digital signal processor 40 to compensate subsequent audio signals with the difference value and output the audible sound through the corresponding speaker.

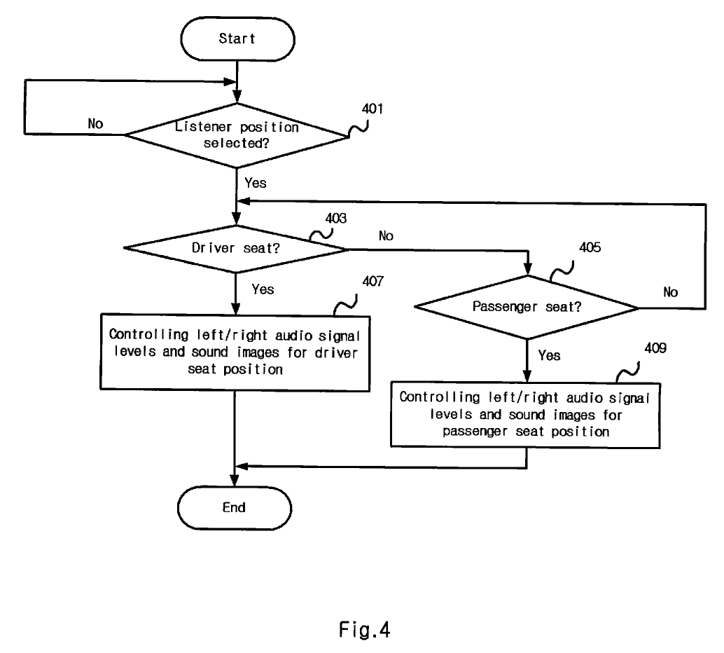

FIG. 4 is a flowchart illustrating a control method of a symmetric acoustic system according to the second embodiment of the present invention.

In the second embodiment of the present invention, the microcomputer 10 should previously store signal level and sound image information on an audio signal outputted to each speaker depending on a listener position.

First, in Step 401, the microcomputer 10 monitors the input unit 25 to determine whether or not data on a key for selecting the listener position is received.

Upon receipt of the position selection key data in the Step 401, in Steps 403 and 405, the microcomputer 10 analyzes the position selection key data to determine whether the listener position is a driver seat 102 or a passenger seat 103.

If it is determined as the determination result that the listener position is the driver seat 102 in the Step 403, in Step 407, the microcomputer 10 reads signal level and sound image information for each of the left and right of the driver seat position, that is, for a left front seat (FL) 41 and a right front seat (FR) 43 from a memory, controls a digital signal processor 40 depending on the signal level and sound image information to control a signal level and a sound image outputted through each speaker, and outputs an audible sound through the corresponding speaker.

On the contrary, if the listener position is determined to be the passenger seat 103 in the Step 405, in Step 409, the microcomputer 10 reads signal level and sound image information for each of the left and right of the passenger seat position, that is, for the left front seat (FL) 41 and the right front seat (FR) 43 from the memory, controls the digital signal processor 40 depending on the signal level and sound image information to control a signal level and a sound image outputted through each speaker, and outputs an audible sound through the corresponding speaker.

As described above, in the present invention, the signal level and the sound image of the audio signal outputted from each speaker are automatically controlled depending on the listener position and therefore, there is an advantage in that the listener can listen the sound with more effective sense of imaging.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A vehicle acoustic system with a plurality of speakers, the system comprising:
a plurality of microphones installed at a position of a listener riding in a vehicle, and outputting an audible sound as an electric audio signal;
a position selector connected with the microphones, and selecting one of the audio signals outputted from the microphones under a predetermined control;
an audio measurement unit for analyzing the audio signal outputted from the position selector, and generating signal level and sound image information for the respective speakers;
an audio signal generator for generating audio data under a predetermined control;
a digital signal processor for, under a predetermined control, controlling a signal level and a sound image of the audio data to be outputted to the respective speaker, converting the audio data into an audio signal, and outputting the converted audio signal as an audible sound through the corresponding speaker; and
a microcomputer for controlling the audio signal generator to generate the audio data, controlling the position selector to select the microphone of the selected position when the listener position is selected by the listener, receiving the signal level and sound image information, comparing the received signal level and sound image information with previously stored reference signal level and sound image information to calculate a difference value between the signal levels and a difference value between the sound images, and controlling the digital signal processor depending on the respective difference values to control the signal level and the sound image of the audio signal outputted through each of the speakers.

2. The system according to claim 1, wherein the microphone is installed at a head pad of a seat at which the ride listener can be positioned.

3. The system according to claim 1, wherein the reference signal level and sound image information is generated through analysis of the audio signal inputted through the microphone, which is provided at a symmetric point for allowing the listener to listen the audible sound with a sense of imaging from the respective speakers.

4. A vehicle acoustic system with a plurality of speakers, the system comprising:
an audio signal generator for generating audio data under a predetermined control;
a digital signal processor for, under a predetermined control, controlling a signal level and a sound image of the audio data to be outputted to the respective speakers, converting the audio data into an audio signal, and outputting the converted audio signal as an audible sound through the corresponding speaker; and
a microcomputer having signal level and sound image information on the audio signals outputted to the respective speakers depending on a listener position, and controlling the audio signal generator to generate the audio data, reading the signal level and sound image information corresponding to the respective speakers for the selected position when the listener position is selected by the listener, and controlling the digital signal processor depending on the read signal level and sound image information to control the signal level and the sound image of the audio signal outputted through the respective speakers.

5. A control method of a vehicle acoustic system with a plurality of speakers, the method comprising the steps of:
determining whether or not a listener position is selected by a listener;
upon selection of the listener position, outputting audio source signals as audible sounds through the speakers;
receiving and analyzing the audio source signals from the respective speakers through a microphone installed at a position corresponding to the listener position, and generating signal level and sound image information on audio signals outputted from the respective speakers;
receiving the generated signal level and sound image information, and comparing the received signal level and sound image information with reference signal level and sound image information to calculate a difference value between signal levels and a difference value between sound images; and
controlling the signal level and the sound image of the audio signal to be outputted to the respective speakers, using the signal level and sound image information based on the respective difference values.

6. A control method of a vehicle symmetric acoustic system having signal level and sound image information on an audio signal outputted to speakers depending on a listener position, the method comprising the steps of:
determining whether or not a listener position is selected;
upon selection of the listener position, reading the signal level and sound image information for each speaker corresponding to the selected listener position; and
controlling a signal level and a sound image of an audio signal to be outputted to each speaker, depending on the read signal level and sound image information.
